(19) United States
(12) Patent Application Publication
(10) Pub. No.: US 2006/0000539 A1
(43) Pub. Date: Jan. 5, 2006

(54) Device and method for automatic recognition of the processing surface of the joining flaps of endless-loop abrasive belts

(75) Inventor: Maurizio Alfieri, Torino (IT)

Correspondence Address: HESLIN ROTHENBERG FARLEY & MESITI PC, 5 COLUMBIA CIRCLE, ALBANY, NY, 12203, US

(73) Assignee: Metis S.r.l., Torino (IT)

(21) Appl. No.: 11/171,932

(22) Filed: Jun. 30, 2005

(30) Foreign Application Priority Data
Jun. 30, 2004 (IT) TO2004A000445

(51) Int. Cl. B31F 5/00; B29C 65/00; B65H 19/00

(52) U.S. Cl. 156/64; 156/502; 156/157

(57) ABSTRACT

An apparatus for processing the joining flaps of flexible abrasive belts for closing them in an endless-loop configuration includes a single conveyor for feeding abrasive belts through a plurality of selective-intervention operating units. Set upstream of each operating unit is a device for automatic recognition of the surface, whether the abrasive one or the substrate, to which the incoming joining flap belongs.

### CROSS-REFERENCE TO RELATED APPLICATIONS

This application claims priority from Italian application number T02004A000445, filed on Jun. 30, 2004, the entire disclosure of which is incorporated herein by reference.

### FIELD OF THE INVENTION

The present invention relates in general to the processing of closed-loop abrasive belts produced starting from materials consisting of a flexible substrate or backing, typically paper, cloth, paper coupled to cloth, laminated polymers or the like. On one face of said flexible substrate is set a layer of abrasive material anchored to the substrate itself by means of resins or glues. The result is a material with two faces, which are very different from one another as regards appearance, colour, coefficient of friction, etc.

The method of fabrication of endless-loop abrasive belts of this sort envisages preparing a semi-finished product of the material described above, typically having the shape of a parallelogram or lozenge. The two ends of the parallelogram, normally consisting of the two opposite smaller sides thereof, are designed to be joined for the formation of the loop. The flaps of said opposite sides are processed with machines that use a motor-driven conveying means including a conveyor, in general consisting of a pair of closed-loop belts, the conveying branches of which grip the abrasive belts between them, feeding them in a working direction, in which successive operating units are prearranged for carrying out the different processing operations. The operating units designed for carrying out said processing operations are obviously different: when the end flaps of the abrasive belt are to be joined together by means of an overlapping join, from one end flap it is necessary to remove the abrasive layer whilst from the other it is necessary, for example, to remove the sizing from the cloth, or else to reduce the thickness in the case of paper.

### STATE OF THE PRIOR ART

In order to be able to process both of the joining flaps of the belt in a single pass there exist machines with two conveyors, generally set one above the other, each designed for one of the two different processing operations described briefly above.

This configuration, which is currently widely used, gives rise to machines of considerable complexity due to the presence of the two conveyors. Furthermore, the configuration of said conveyors set one above the other renders any intervention for regulating the operating units associated to the top conveyor inconvenient.

A simpler and more economically advantageous alternative is represented by machines with a single conveyor, in which the two end flaps of the belts are processed in two successive passes, and hence involve twice the processing time. In this case, the various operating units can be provided with actuators, which can be controlled manually by the operator by means of switches set on the control panel of the machine, which displace the operating units—with respect to the path of feed of the belts in the working direction—between an operating position and a parking position, according to a selection made by the operator himself. Said selection makes it possible to choose and render operative the units prearranged for processing of the abrasive side or else of the substrate side or backing of the belts.

The above solution, albeit constructively simpler than the one that uses two conveyors set one above the other, as has been said involves doubling of the production times and moreover requires the intervention of specialized staff.

### OBJECT OF THE INVENTION

The purpose of the present invention is to overcome the aforesaid drawbacks and make possible the use of machines with a single conveyor capable of operating on the flaps of both of the ends of the belt in a single pass, at the same time reducing human intervention to simple control functions.

### SUMMARY OF THE INVENTION

With a view to achieving the above purpose, the subject of the invention is an apparatus for processing the joining flaps of flexible abrasive belts of the type described above, basically characterized in that it comprises sensor means for automatic recognition of the type of surface of said joining flaps of the abrasive belts during their feed in the working direction, and control means interlocked to said sensor means for automatic operation of selective intervention of the aforesaid operating units.

In a preferred embodiment of the invention, the sensor means are prearranged for detecting an orientation of the larger front side of the belt, with reference to advance of the abrasive belt in the working direction, with respect to said working direction.

Thanks to the proposed inventive idea of solution, all the drawbacks of the known apparatuses described above are overcome, with the further advantage of being able to dedicate some operating units indifferently to the abrasive side or else to the substrate side or backing of the abrasive belts. The sensor means are able to recognize which face of the belt is facing upwards, i.e., the side that is to be processed by the operating units, and the signal of recognition generated by said sensor means is used for governing the motor-driven actuators that set the different operating units in the working position or else keep them in the parking position.

The subject of the invention is also a method for automatic recognition of the processing surface of the joining flaps of flexible abrasive belts so that they can subsequently overlap in order to form an endless loop, in which the abrasive belts have the shape of a parallelogram, with two opposite sides defining said joining flaps, and are fed in a direction of conveyance along which operating units are provided, which are selectively activatable according to said processing surfaces, and in which said abrasive belts substantially have the shape of a parallelogram, with two opposite sides defining said joining flaps, said method basically being characterized in that it comprises the following operations:

providing sensor means in said direction of conveyance;

feeding the abrasive belts in said direction of conveyance in a substantially V-shaped folded configuration, with said joining flaps arranged parallel to said direction of conveyance, so that the folded portions of the other two opposite sides of the abrasive belts form, in one case, an acute angle or, in the other, an obtuse angle, with said direction of conveyance;

detecting said angle by means of said sensor means; and

automatically enabling selective intervention of said operating units according to the angle detected by said sensor means.

### BRIEF DESCRIPTION OF THE DRAWINGS

The invention will now be described in greater detail with reference to the annexed plate of drawings, which are provided purely by of way of non-limiting example and in which:

FIG. 1 is a schematic perspective view of a part of an apparatus for processing abrasive belts according to the invention; and

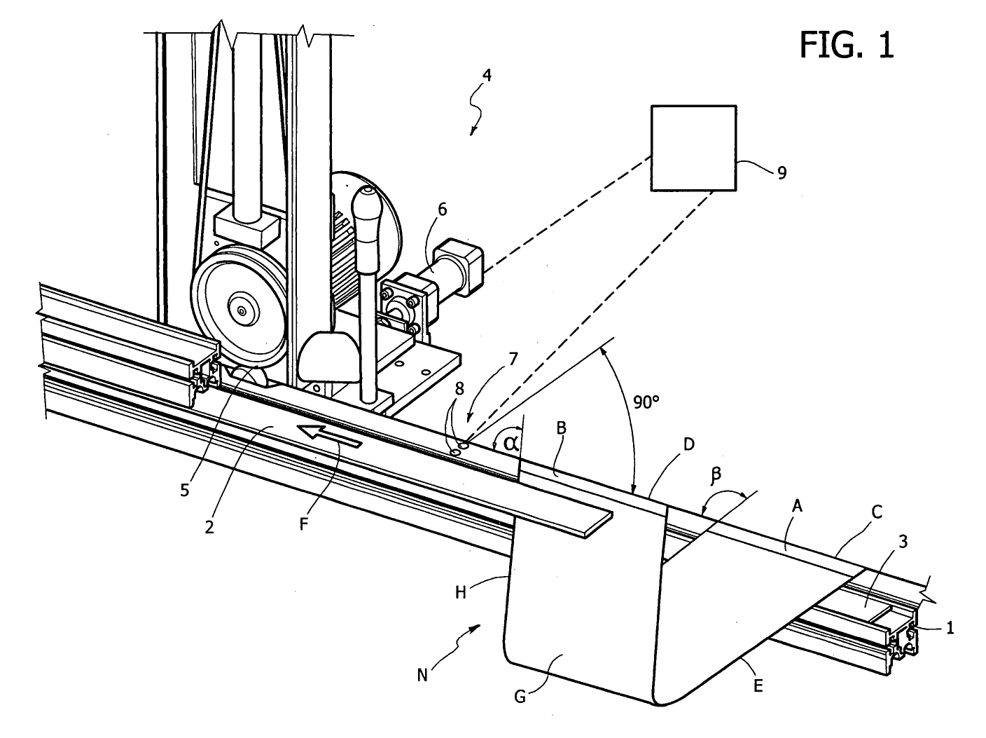

FIG. 2 is a top plan view of the part of apparatus illustrated in FIG. 1.

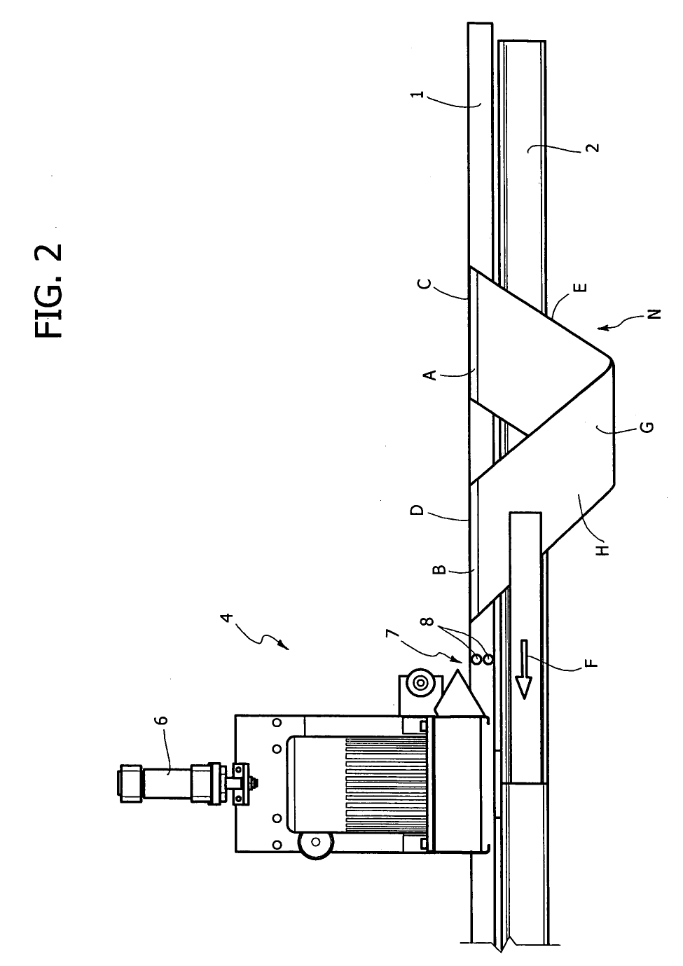

### DETAILED DESCRIPTION OF THE INVENTION

The drawings illustrate schematically an embodiment of an apparatus for processing the overlapping joining flaps A, B of flexible abrasive belts N. The illustrations represent only a part of the apparatus, the longitudinal extension of which is normally much greater.

As briefly explained previously, each abrasive belt N presents, when laid out flat, a parallelogram or lozenge-shaped conformation in plan view, with the joining flaps A, B situated along the two opposite minor sides C, D of the parallelogram, which form with the two opposite major sides E, F thereof angles different from 90°.

As has likewise already been clearly explained, the belt N consists of a flexible band or substrate (paper, cloth, paper coupled to cloth, laminated polymers or the like), on one face of which, for example the one designated by G, is applied a layer of abrasive material.

The processing apparatus basically comprises a longitudinal structure 1, along which there extends a single motor-driven conveyor consisting of a pair of closed-loop belts, the conveying branches of which, designated one by 2 and the other by 3, are set one above the other and are mobile in a direction of conveyance or of working indicated by the arrow F along the longitudinal structure 1.

Set alongside the longitudinal structure 1 is a plurality of operating units, only one of which is represented schematically and is designated by 4.

The general conformation of the operating unit 4 is in itself known, and will consequently not be described in detail herein. For the purposes of the present invention, it is sufficient to clarify that said unit 4 (as likewise the further units arranged along the structure 1 of the apparatus) comprises an operating assembly 5 configured for carrying out the specific processing operation required for the flap A or else for the flap B of the belts N, and a motor-driven actuator 6, by means of which the operating unit 4 is moved crosswise with respect to the structure 1 between a retracted, parking, position and an advanced, working, position. For processing of the abrasive face of the belt N, the unit 4 will, for example, be prearranged for removal of the layer of abrasive material, whilst as regards the opposite face the operating unit 4 will be configured for removing the sizing from the cloth, or else for reducing the thickness in the case of paper.

According to the basic characteristic of the invention, immediately set upstream of the operating unit 4 with reference to the working direction F is a sensor device, designated as a whole by 7, for automatic recognition of the type of surface of the belt N transferred thereto by the conveyor 2, 3. In the case of the example illustrated, the sensor assembly 7 consists of a pair of optical sensors 8 carried by the structure 1 and aligned to one another in a direction perpendicular to the direction of conveyance F of the belt N. Of course, it is possible to envisage, within the scope of the present invention, sensors of a different type, for example, ones consisting of simple microswitches.

The sensor assembly 7 is operatively connected to a control circuit, for example consisting of a programmable controller, designated as a whole by 9, which governs displacement of the operating unit 4 between the retracted, parking, position and the advanced, working, position.

Operation of the apparatus according to the invention is described in what follows.

The abrasive belt N is loaded onto the conveyor, being set, in the way illustrated in the figures, according to a substantially V-shaped folded configuration, with the opposite minor sides C, D corresponding to the joining flaps A, B aligned to one another parallel to the working direction F. With said arrangement, the joining flaps A, B form with the line joining the two sensors 8 an angle of 90°, whilst the other two opposite sides E, H of the belt N are positioned with respect to the direction of conveyance F according to angles different from 90°. More in particular, the front side H (with reference to the working direction F) will form, at the front branch of the V-shaped configuration, an acute angle a, whilst the same front side H will form, at the rear branch of the V-shaped configuration, an obtuse angle β. It is precisely the difference of the angles α and β that enables, by means of the two sensors 8, recognition of whether the surface of the belt N approaching the operating unit 4 is the abrasive one or else that of the substrate. In fact, assuming, as has already been said, that the abrasive face of the belt N is the one designated by G, the two sensors 8 will detect, during passage of the belt N, first the acute angle α (since, in this case, the front side H will initially intercept the outermost sensor 8 and subsequently the innermost sensor 8), and then the obtuse angle β (since the side H, in this case, will first intercept the innermost sensor 8 and subsequently the outermost sensor 8). Consequently, the sensor assembly 8 will first determine passage of the flap D corresponding to the abrasive face G, and subsequently of the flap A corresponding to the opposite non-abrasive face of the belt. In the case where the operating unit 4 is provided for processing of the abrasive flap B, the controller 9 interlocked to the sensor assembly 7 will then issue a command for actuation of the actuator 6 corresponding to advance of the operating units 4 towards the working position, and then, at the end of the processing of the flap B, will govern the actuator 6 in the direction corresponding to return of the operating unit 4 towards the retracted, parking, position, so as not to interfere with the other flap A of the belt N.

Operation is identical for all the operating units 4 that will subsequently be encountered by the belt N in the course of its feed in the working direction F along the structure 1 of the apparatus.

It will appear evident from the foregoing that the apparatus according to the invention enables, with a single conveyor, operation on both of the joining flaps A, B of the belts N in a single pass. The various processing operations do not require human intervention, other than for simple control functions, since enabling or disabling of the various operating units arranged in the working direction of the belts is actuated in a completely automatic way. This contributes further to reducing appreciably the times of the entire cycle of processing of the belts.

Of course, the details of implementation and the embodiments may vary widely with respect to what is described and illustrated herein, without thereby departing from the scope of the present invention, as defined in the ensuing claims.

What is claimed is:

1. An apparatus for processing joining flaps of flexible abrasive belts that substantially have the shape of a parallelogram, with two opposite sides defining said joining flaps for closing each belt in an endless-loop configuration, said apparatus comprising conveying means for feeding the abrasive belts in a working direction, along which successive operating units are arranged for selective intervention thereof according to the type of surface of said joining flaps, said apparatus comprising sensor means for automatic recognition of the type of surface of said joining flaps of the belts during their feed in said working direction, and control means interlocked to said sensor means for automatic operation of selective intervention of said operating units.

2. The apparatus according to claim 1, wherein said sensor means are prearranged for detecting an orientation of a front side of each abrasive belt, with reference to feeding of each abrasive belt in the working direction, with respect to said working direction.

3. The apparatus according to claim 2, wherein said conveying means include a single conveyor provided for withholding the abrasive belts in a substantially V-shaped folded configuration, with the opposite sides of the belts corresponding to said joining flaps arranged parallel to the working direction so that the folded portions of the other two opposite sides of the abrasive belts form an acute angle or an obtuse angle, respectively, with said working direction, and in that said sensor means detect said angles.

4. The apparatus according to claim 3, wherein said sensor means include a pair of sensors aligned to one another in a direction orthogonal to said working direction upstream of each operating unit of the operating units with reference to advance of the belts along said working direction.

5. The apparatus according to claim 4, wherein said sensors are of an optical or mechanical type.

6. A method for automatic recognition of the surface of processing of joining flaps of flexible abrasive belts so that they can subsequently be superimposed on one another in order to close each belt in an endless-loop configuration, in which said abrasive belts substantially have the shape of a parallelogram, with two opposite sides defining said joining flaps, and are fed in a direction of conveyance, along which operating units are prearranged, said units being selectively activatable and deactivatable according to said processing surfaces, said method comprising the following steps:
providing sensor means in said direction of conveyance upstream of said operating units;
feeding the abrasive belts in said direction of conveyance in a substantially V-shaped folded configuration, with the two opposite sides of the belts corresponding to said joining flaps arranged parallel to said direction of conveyance, so that the folded portions of the other two opposite sides of the abrasive belts form an acute angle or, respectively, an obtuse angle with said direction of conveyance;
detecting said angle by means of said sensor means; and
automatically enabling selective intervention of said operating units according to the angle detected by said sensor means.

7. The method according to claim 6, wherein advance of the belts in said direction of conveyance is performed by means of a single conveyor.
